(19) United States
(12) Patent Application Publication
(10) Pub. No.: US 2016/0203205 A1
(43) Pub. Date: Jul. 14, 2016

(54) Common Cell Algorithm for LRS Segment Join Operations

(71) Applicant: Bo Guo, Chandler, AZ (US)

(72) Inventor: Bo Guo, Chandler, AZ (US)

(21) Appl. No.: 14/992,999

(22) Filed: Jan. 11, 2016

Related U.S. Application Data
(60) Provisional application No. 62/102,025, filed on Jan. 11, 2015.

(51) Int. Cl. G06F 17/30

(52) U.S. Cl. CPC G06F 17/30592

(57) ABSTRACT

In the linear location referencing system (LRS) domain, one of the key challenges is joining LRS segments from different datasets by their common spatial (spatiotemporal) existence. The invented LRS join algorithm is based on relational algebra that provides high performance along with algorithmic clarity. It addresses what the prior art has failed to address or address performantly.

The invented algorithm first generates a cell mesh for each route, which is then used to decompose the segments participating in the join operations. The resulting segments are determined based on the cell population configuration. Finally, the results are coalesced to keep LRS datasets compact and normalized.

### CROSS-REFERENCE TO RELATED APPLICATIONS

Provisional Patent Application No. 62/102,025

### STATEMENT REGARDING FEDERALLY SPONSORED RESEARCH OR DEVELOPMENT (IF APPLICABLE)

No federally sponsored research and development was involved in the development of this patented technology.

### REFERENCE TO SEQUENCE LISTING, A TABLE OR A COMPUTER PROGRAM LISTING COMPACT DISC APPENDIX (IF APPLICABLE)

None

### BACKGROUND OF THE INVENTION

A Linear (Location) Referencing System (LRS) allows assets/events along routes, or common linear structures (such as streets or canals), to relate to each other based on their locations. In its simplest form, an LRS location is represented by route name and pairs of measurements along the route.

LRS has wide industry applications in transportation and utility sectors such as highway, rail, pipeline and water transportation, power and water distribution. The adoption of an LRS data model results in separation of assets/events of different types in different datasets. As a result, joining various LRS-referenced assets/events based on location is desirable but challenging.

### DEFINITIONS AND NOTATIONS

### LRS Segment or Segment

An LRS data record in an LRS dataset representing a segment having homogenous non-spatial attributes along its spatial dimension or spatiotemporal dimensions. A spatiotemporal LRS segment is expressed in Eq 1. When bd, ed are undefined, the segment is one-dimensional.

S={sid,rid,fm,tm,bd,ed,a₁, . . . aₙ} Eq 1

where
sid unique segment key representing the asset/event
rid route key representing the route to which asset/event belongs
fm, tm route measurements pair representing asset/event location
bd, ed time period when the asset/event is valid
a₁, . . . aₙ non-spatial attributes of asset/events

### LRS Dataset

A set of LRS segments representing one type of asset or event. In sample example, dataset A has a collection of segments on route SR 101 representing street pavement types, while dataset B contains segments depicting pavement condition ratings.

### Route

In the LRS domain, a physical transport facility such as a street in a road network, is simulated by a data structure called route that contains measurements relative to its beginning point on its dimension(s). A route space is bounded on its dimensions (FIG. 1).

### Cell

Subdivisions of a route space to hold zero or more segments (FIG. 1).

### Segment Decomposition

A process that divides one segment into two or more segments along its spatial dimension(s).

### Segment Coalesce

The process of merging adjacent segments having homogenous non-spatial attributes along its dimension(s).

### Segment Join

Two segments form a join relationship when they share common spatial (or spatiotemporal) existence, i.e. when they reside on the same route with overlapping or coincident measure ranges. LRS Segment Join belongs to the intersection join category as opposed to the entity join category. The intersection of the joining segments categorizes the results of the join types—inner join, left-outer join, right-outer join and full join operations. See illustrations in FIG. 2.

### Sample Datasets

Two sample LRS datasets are used to describe the issues and the algorithm: Table 1 and Table 2 illustrate pavement surface type segments and pavement condition index segments on a route SR 101. Both datasets are two-dimensional (spatiotemporal), and are depicted in a Time-Space Diagram as in FIG. 3 and FIG. 4, respectively. Each block in the Figures corresponds to a segment in the corresponding dataset.

### The Challenges

The two datasets represent a normalized LRS design where LRS-referenced data (assets or events) are stored and managed separately from each other. Relating or joining the different feature datasets spatially is the question. For example, Table 3 represents the Inner Join of the datasets, while Table 4 represents right-outer joins of dataset one and dataset two. FIG. 9 and FIG. 10 show results of the two join operations in Time-Space Diagrams, respectively.

### The Prior Art: Nested-Loop Approach

Through a pair of nested loops, each segment in Set A is tested against each segment in Set B for intersecting relationships. If the two segments intersect (overlapping or coincident dimensional ranges on the same route) the segments are decomposed to create the common (the intersection) part and the remaining parts.

Two source datasets:
SET A has m segments {aᵢ|aεS, i=1, . . . m}
SET B has n segments {bⱼ|bεS, j=1, . . . n}

The resulting dataset:
SET C has p segments {cₖ|cεS, k=1, . . . p}

Pseudo code for inner join of Set A and Set B using the nested-loop method:

```
FOR i = 1 TO m
      FOR j = 1 TO n
            IF aᵢ Intersects bⱼ THEN
                  APPEND C WITH
                  { c.sid,
                          aᵢ.sid,
                          bⱼ.sid,
                          MAX(aᵢ.fm, bⱼ.fm),
                          MIN(bᵢ.tm, bⱼ.tm),
                          MAX(aᵢ.bd, bⱼ.bd),
                          MIN(bᵢ.ed, bⱼ.ed)}
            END IF
      LOOP
LOOP
```

There are two main flaws of the nested-loop method. First, the implementation of the seemingly simple logic gets very complicated when the following conditions exist:

1) segment overlap exists within a dataset,

2) more than two datasets are involved,

3) segment dimensions in the datasets are different,

4) segments are multi-dimensional, and

5) outer-join operations are requested.

Secondly, the code logic is not performant.

### BRIEF SUMMARY OF THE INVENTION

The new LRS segment join algorithm uses the intersection of the LRS segments to decompose segments from the joining sets so that each decomposed segment will completely fill one and only one cell. The cells occupied by decomposed segments from both sets represent the inner join result. The cells that are occupied only by decomposed segments from one of the two sets hold the results that belong to the respective Outer-join operations. The final step in the approach calls for the coalescing of the adjacent decomposed segments that share the same non-spatial attribute values a₁, . . . aₙ.

The invented algorithm is developed based on relational algebra, which provides natural support for the join types and optimizes for set operations. The same algorithm supports all the conditions that the nested-loop method fails to adequately or efficiently handle.

### DETAILED DESCRIPTION OF THE INVENTION

The illustration is in the 2-D space; the approach applies to 1-D as well as multi-dimensional LRS datasets. The invented algorithm can be described in the following steps:
1. Create cells by meshing route spaces occupied by all segments in the joining datasets for each route. FIG. 5 shows the cells resulting from meshing route space on SR 101 from two sample datasets. The cells represent the area common in the spatiotemporal space to the two sets.
2. Use the cell mesh created in Step 1 to “decompose” the segments in datasets so each decomposed segment will populate, in the full extent of the cell, one and only one cell (FIG. 6).
3. Organize the decomposed segments by different join types based on their cell population configuration. Table 5 shows the cell population configuration for various join operations.
4. Coalesce decomposed join operation results generated in Step 3 along segment dimensions. For spatiotemporal segments, the spatial dimension of each time slice (FIG. 7) is coalesced, before coalescing the temporal dimension for segments with identical measure ranges (FIG. 8).
5. FIG. 9 and FIG. 10 illustrate the final results of the join operations of the two sample datasets.

### BRIEF DESCRIPTION OF DRAWINGS

FIG. 1. Illustration of Route and Cells

This figure is NOT part of the invention, it is provided as background information.

The figure shows that cells represent a subdivision of a route space

FIG. 2. Illustration of Segment Join Operations

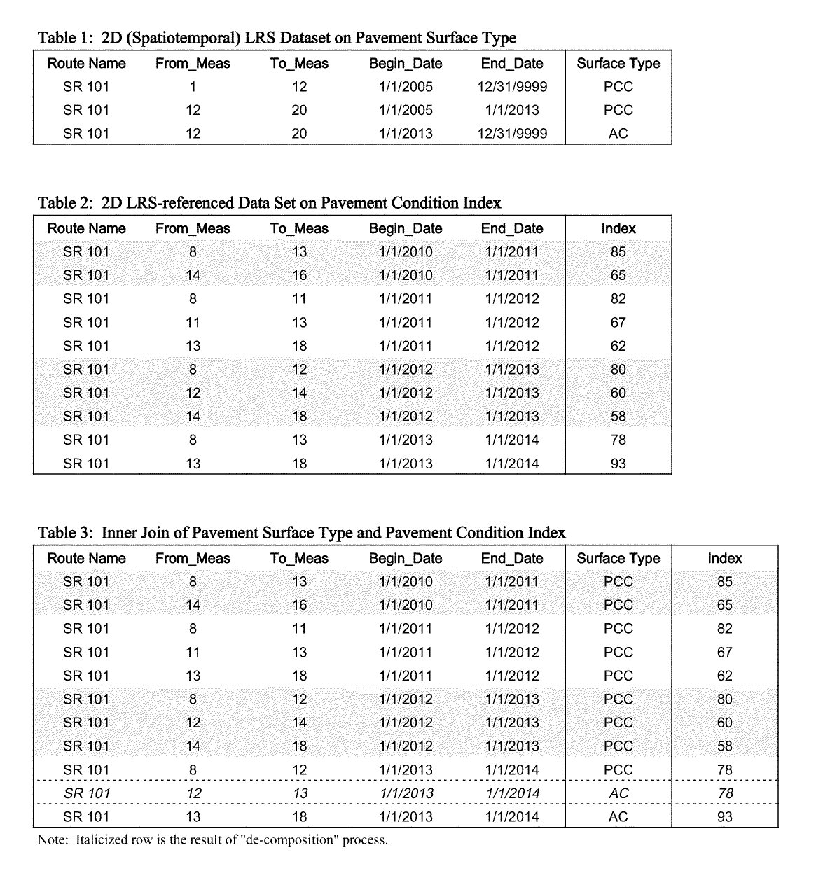

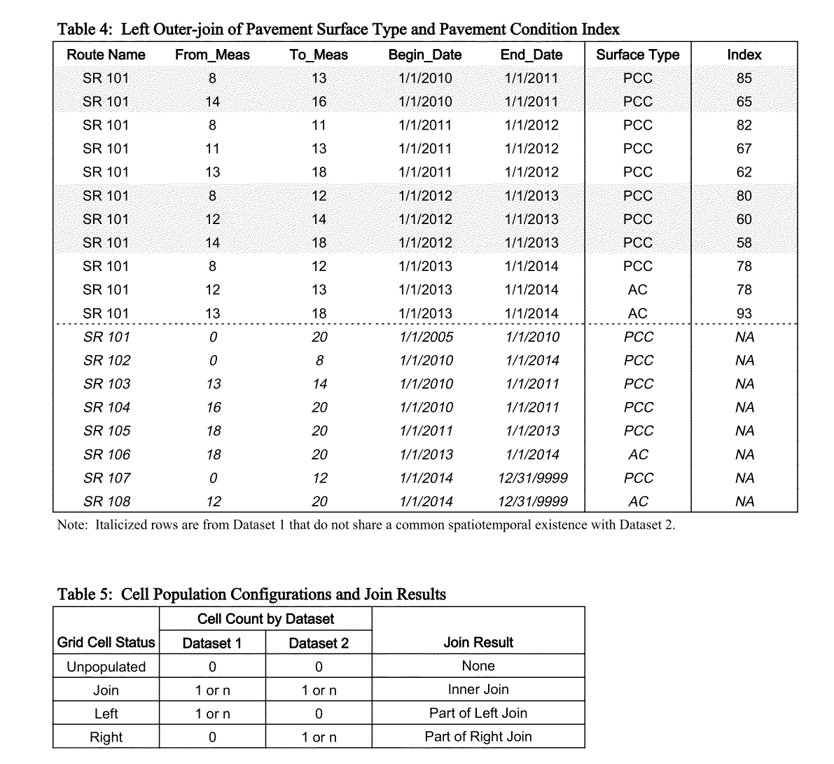

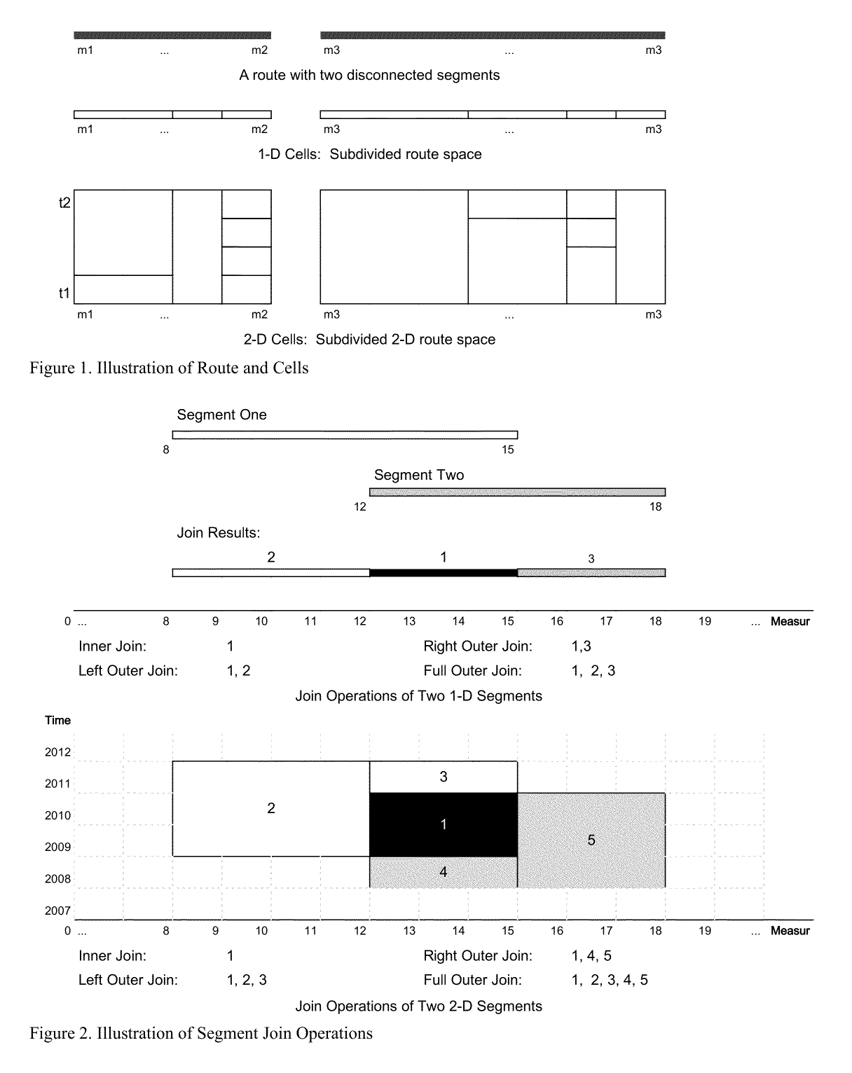

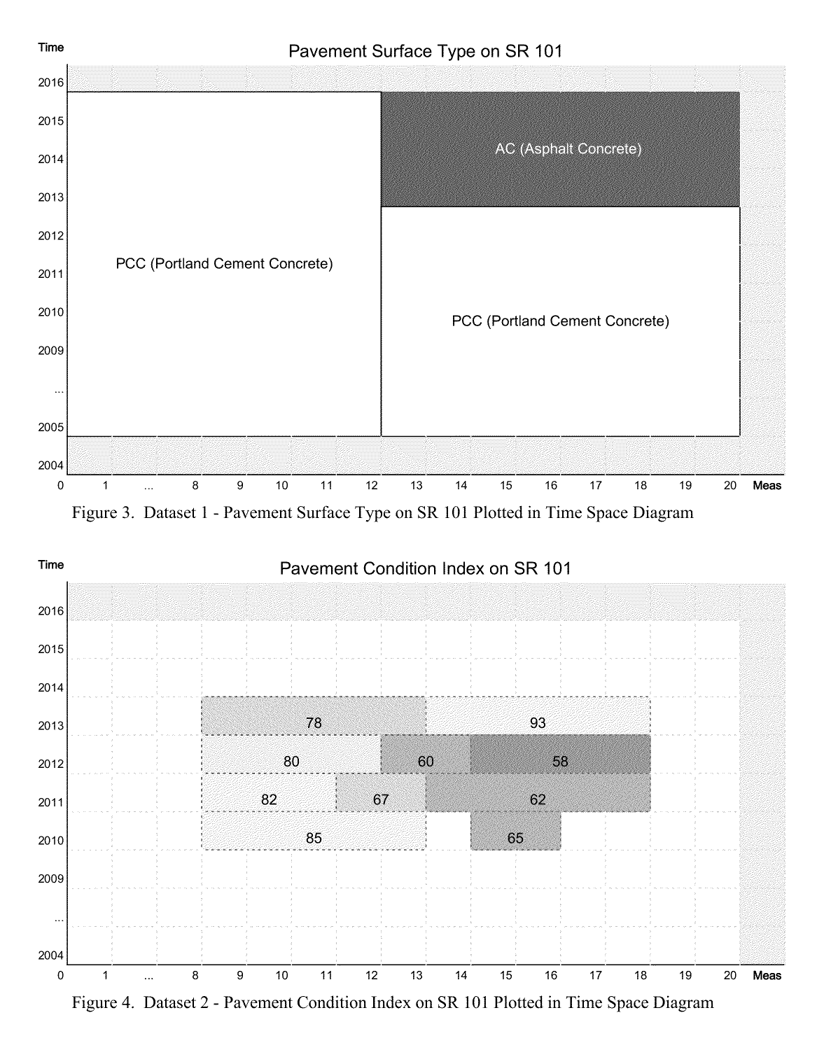

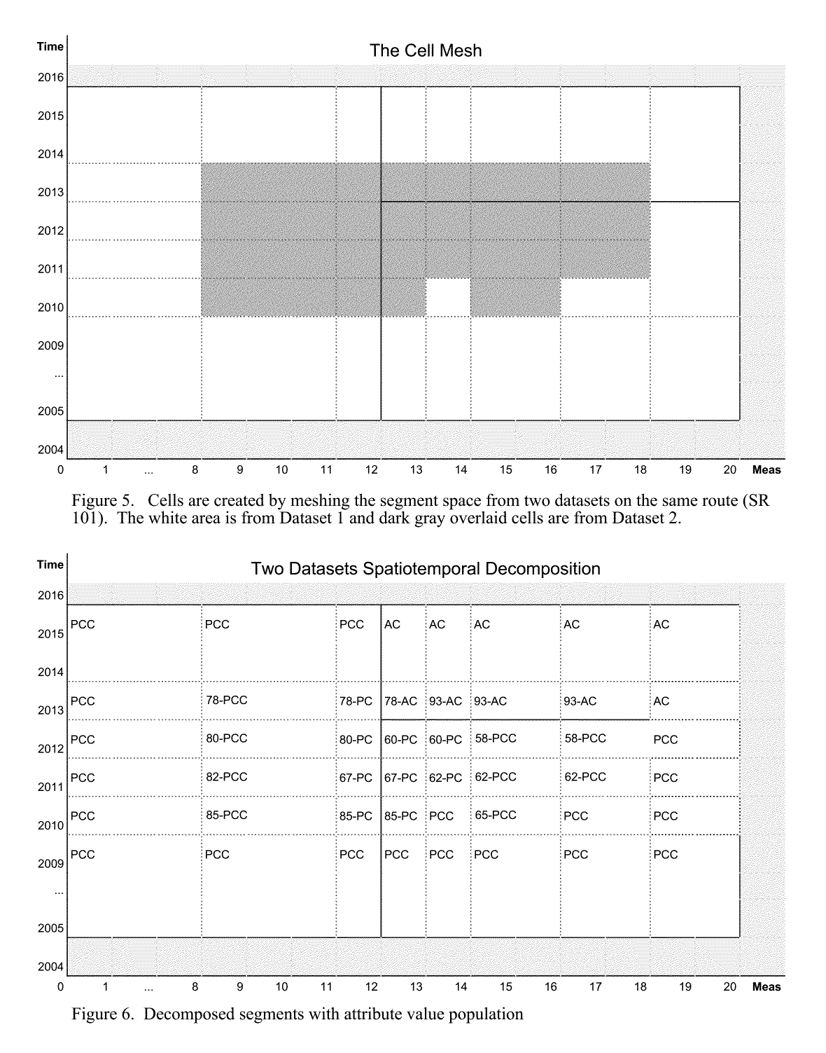

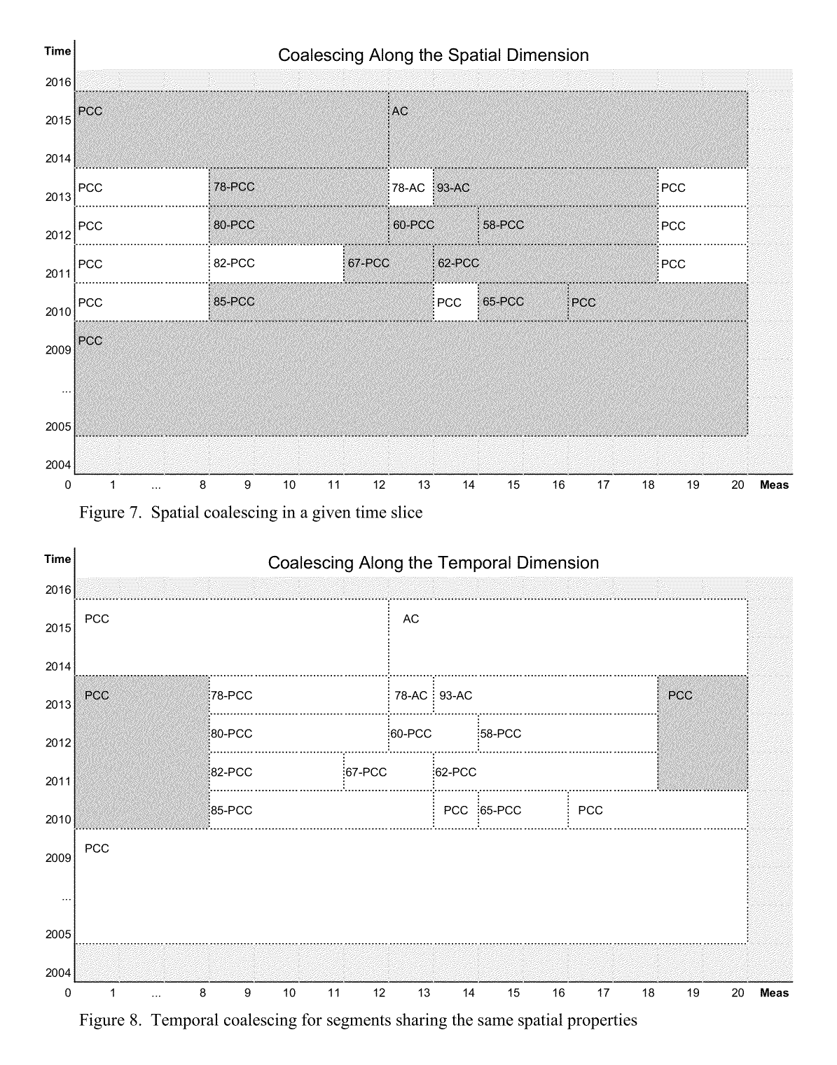

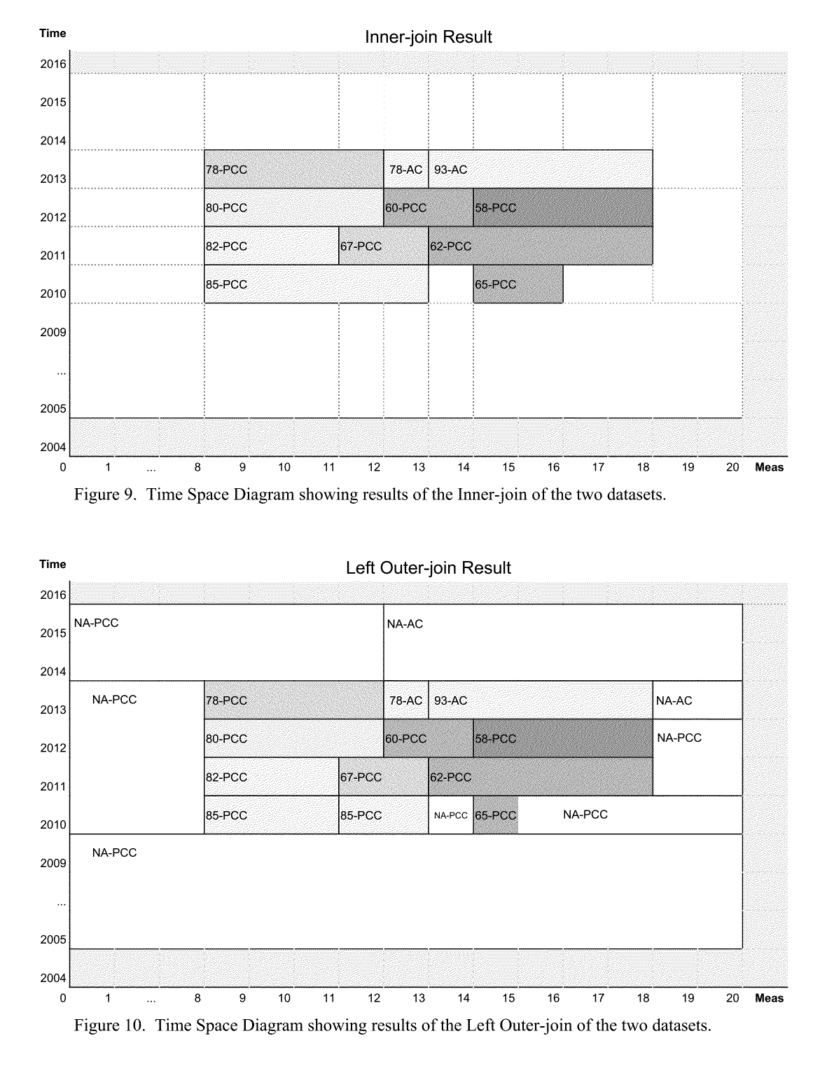

This figure is NOT part of the invention, it is provided as background information.

The figure shows what typical segment join operations are in the two dimensional space. Two segments form a join relationship when they share common spatial (or spatiotemporal) existence, i.e. when they reside on the same route with overlapping or coincident measure ranges. LRS Segment Join belongs to the intersection join category as opposed to the entity join category. The intersection of the joining segments categorizes the results of the join types—inner join, left-outer join, right-outer join and full join operations.

FIG. 3. Dataset 1—Pavement Surface Type on SR 101 Plotted in Time Space Diagram, and

FIG. 4. Dataset 2—Pavement Condition Index on SR 101 Plotted in Time Space Diagram

The illustrations are NOT part of the invention, they are provided as background information

The two Time-Space Diagrams depict two sample LRS datasets in the spatiotemporal dimensions, Each block in the Figures corresponds to a segment in the corresponding dataset.

FIG. 5. Cells are created by meshing the segment space from two datasets on the same route (SR 101). The white area is from Dataset 1 and dark gray overlaid cells are from Dataset 2

This figure illustrates the first step in the invented algorithm. Cells are created by meshing route spaces occupied by all segments in the joining datasets for each route. Specifically, the figure shows the common cells resulting from meshing route space from two sample datasets.

FIG. 6. Decomposed segments with attribute value population

This figure illustrates the second step in the invented algorithm, where the common cells generated in the first step are used to to “decompose” the segments in datasets so each decomposed segment will populate, in the full extent of the cell, one and only one cell.

FIG. 7. Spatial coalescing in a given time slice, and

FIG. 8. Temporal coalescing for segments sharing the same spatial properties

The figures illustrate the forth step in the invented algorithm, where decomposed cells are coalesced along each of the cell dimensions. For spatiotemporal segments, the spatial dimension of each time slice (FIG. 7) is coalesced, before the temporal dimension is coalesced (FIG. 8).

FIG. 9. Time Space Diagram showing results of the Inner-join of the two datasets, and

FIG. 10. Time Space Diagram showing results of the Left Outer-join of the two datasets

FIG. 9 and FIG. 10 illustrate the final results of the two join operations (inner-join, and left outer-join respectively) of the two sample datasets.

1. A method enables structured and performant join operations of two or more multi-dimensional LRS datasets. The methodology is described in the following steps: a) create a cell mesh for each route that are shared by segments in the joining datasets. b) decompose the segments using the cell mesh so that each resulting segment fully populates one and only one cell. c) collect the decomposed segments in each dataset by different join types based on their cell population configuration. d) coalesce resulting segments along their dimension(s).
